(19) United States
(12) Patent Application Publication
(10) Pub. No.: US 2022/0104923 A1
(43) Pub. Date: Apr. 7, 2022

(54) INTRAORAL MEASUREMENT DEVICE

(71) Applicant: Konica Minolta, Inc., Tokyo (JP)

(72) Inventors: Yoshihiro INAGAKI, Tokyo (JP); Atsushi NAGAOKA, Okazaki-shi (JP)

(21) Appl. No.: 17/494,966

(22) Filed: Oct. 6, 2021

(30) Foreign Application Priority Data
Oct. 6, 2020 (JP) 2020-169153

(51) Int. Cl. A61C 9/00; G02B 5/04

(52) U.S. Cl. CPC A61C 9/006; G02B 5/04

(57) ABSTRACT

Provided is an intraoral measurement device that enables high-accuracy profilometry with a simple device configuration using a prism.

### CROSS-REFERENCE TO RELATED APPLICATIONS

The present invention claims priority under 35 U.S.C. §119 to Japanese patent Application No. 2020-169153, filed on Oct. 6, 2020, the disclosure of which is incorporated herein by reference.

### BACKGROUND

### Technological Field

The present invention relates to an intraoral measurement device.

### Description of the Related Art

An intraoral measurement device is an intraoral profilometry technique for teeth and gums. The following Patent Literature 1 discloses a technique related to the device. In a device disclosed in Patent Literature 1, light from a light source passes through a condenser lens, and a pattern mask including an LCD shutter or the like is irradiated with the light. The pattern mask generates fringe patterns, and the generated fringe patterns are projected onto teeth and gums, that is, objects of interest, via a diaphragm and a condenser-objective lens. The device also includes a beam splitter in order to separate a beam from the light source into a projection light path and an observation light path. The fringe patterns of light are finally received by an image sensor such as CCD via an imaging lens.

In addition, there is an intraoral measurement device including a prism on an optical path of projection light applied to an object of interest and on an optical path of observation light from the object of interest toward an imaging element. In this device, the projection light and the observation light are reflected inside the prism, thereby reducing a thickness of a leading end of the prism that faces the object of interest.

### RELATED ART LITERATURE

### Patent Literature

Patent Literature 1: JP 2009-165558 A

### SUMMARY

However, in a device using a prism, in order to separate projection light and observation light, at least one of the projection light and the observation light is required to be incident on the prism obliquely to provide an angular difference between the two optical paths. Therefore, the influence of oblique incidence on the prism is corrected with an aberration correction element, which complicates the device configuration. Furthermore, variations in accuracy and position of components in the aberration correction element may cause errors, which may cause performance deterioration.

An object of the present invention is to provide an intraoral measurement device that enables high-accuracy profilometry with a simple configuration using a prism.

In order to achieve the object, the present invention provides an intraoral measurement device including:

a projector that emits projection light;

an imager that receives imaging light, that is, the projection light reflected on an object of interest; and

a prism that guides the projection light emitted from the projector to the object of interest and guides the imaging light or the projection light reflected on the object of interest toward the imager, the prism being disposed on an optical path between the projector and the imager,

in which the prism includes a light transmissive surface playing both roles as an incident surface of the projection light and an emitting surface of the imaging light and includes an imaging surface facing the object of interest and playing both roles as an emitting surface of the projection light and an incident surface of the imaging light, and

the imager has an optical axis parallel to a normal of the light transmissive surface and a normal of the imaging surface of the prism.

According to an embodiment of the present invention, it is possible to provide an intraoral measurement device that enables high-accuracy profilometry with a simple configuration using a prism.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a perspective view illustrating a schematic configuration of an intraoral measurement device according to an embodiment;

FIG. 2 is a view illustrating configurations of an illuminator and a projector in the intraoral measurement device according to the embodiment;

FIG. 3 is a view (part 1) illustrating schematic optical paths of light used in the intraoral measurement device according to the embodiment;

FIG. 4 is a view (part 2) illustrating schematic optical paths of light used in the intraoral measurement device according to the embodiment;

FIG. 5 is a developed view illustrating the configuration of the intraoral measurement device according to the embodiment;

FIG. 6 is a view (part 1) illustrating projection patterns projected onto an object of interest in the intraoral measurement device according to the embodiment;

FIG. 7 is a view (part 2) illustrating projection patterns projected onto an object of interest in the intraoral measurement device according to the embodiment;

FIG. 8 is a view (part 1) illustrating an imaging pattern captured with the intraoral measurement device according to the embodiment; and

FIG. 9 is a view (part 2) illustrating an imaging pattern captured with the intraoral measurement device according to the embodiment.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of an intraoral measurement device to which the present invention is applied will be described in detail with reference to the drawings.

<<Configuration of Intraoral Measurement Device>>

FIG. 1 is a perspective view illustrating a schematic configuration of an intraoral measurement device 1 according to an embodiment. In the intraoral measurement device 1 illustrated in FIG. 1, optical components, that is, an illuminator 100, a projector 200, a prism 300, and an imager 400 are arranged in this order which is a route of optical paths. In FIG. 1, for example, the longitudinal direction of the prism 300 is referred to x-direction, the width direction perpendicular to x-direction is referred to as y-direction, and the thickness direction perpendicular to x-direction and y-direction is referred to as z-direction. Furthermore, in FIG. 1, light H0, light H1, and light H2 used in the intraoral measurement device 1 represent rays along optical axes of the illuminator 100, the projector 200, and the imager 400, respectively. Note that light inside the prism 300 included in the intraoral measurement device 1 is not shown.

The intraoral measurement device 1 illustrated herein is unique in shape of the prism 300 and arrangement of each optical component. Hereinafter, configurations of the illuminator 100, the projector 200, the prism 300, and the imager 400 will be described in this order along the route of the optical paths.

<Illuminator 100>

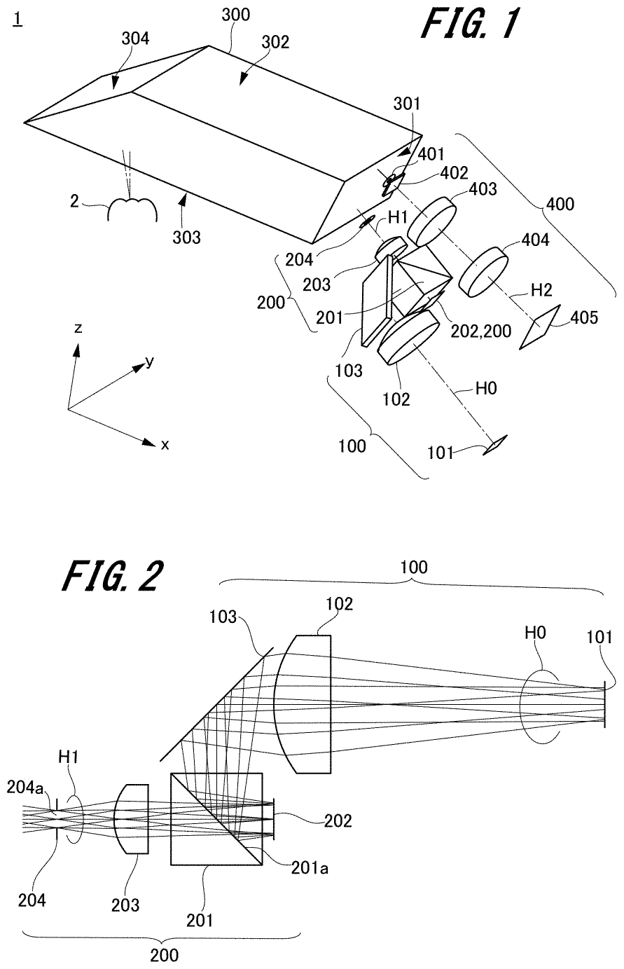

FIG. 2 is a view illustrating the configurations of the illuminator 100 and the projector 200 in the intraoral measurement device 1 according to the embodiment. In this drawing, the illuminator 100 and the projector 200 are viewed in an intermediate direction between x-direction and z-direction in FIG. 1. In FIG. 2, the light H0 and the light H1 used in the intraoral measurement device 1 are illustrated as beams. As illustrated in FIG. 2 and the aforementioned FIG. 1, the illuminator 100 supplies the illumination light H0 to the projector 200. The illuminator 100 includes a light source 101 that generates the illumination light H0 and includes an illuminator lens 102 and a mirror 103 along the route of the optical path of the illumination light H0 emitted from the light source 101. Details are given below.

[Light Source 101]

The light source 101 is, for example, a light emitting diode (LED) that irradiates the illuminator lens 102 with the illumination light H0. The illumination light H0 emitted from the light source 101 spreads and is applied to the illuminator lens 102 (see FIG. 2).

[Illuminator Lens 102 and Mirror 103]

The illuminator lens 102 condenses the illumination light H0 generated by the light source 101 and spread therefrom. The mirror 103 reflects the illumination light H0 passing through the illuminator lens 102 toward the projector 200.

<Projector 200>

The projector 200 generates predetermined projection patterns for the illumination light H0 supplied from the illuminator 100 and forms projection light H1, thereby irradiating the prism 300 with the projection light H1 having the projection patterns. The projector 200 includes a polarized beam splitter 201, a display element 202, a projector lens 203, and a projector aperture 204 in this order along the route of the optical paths of the illumination light H0 and the projection light H1.

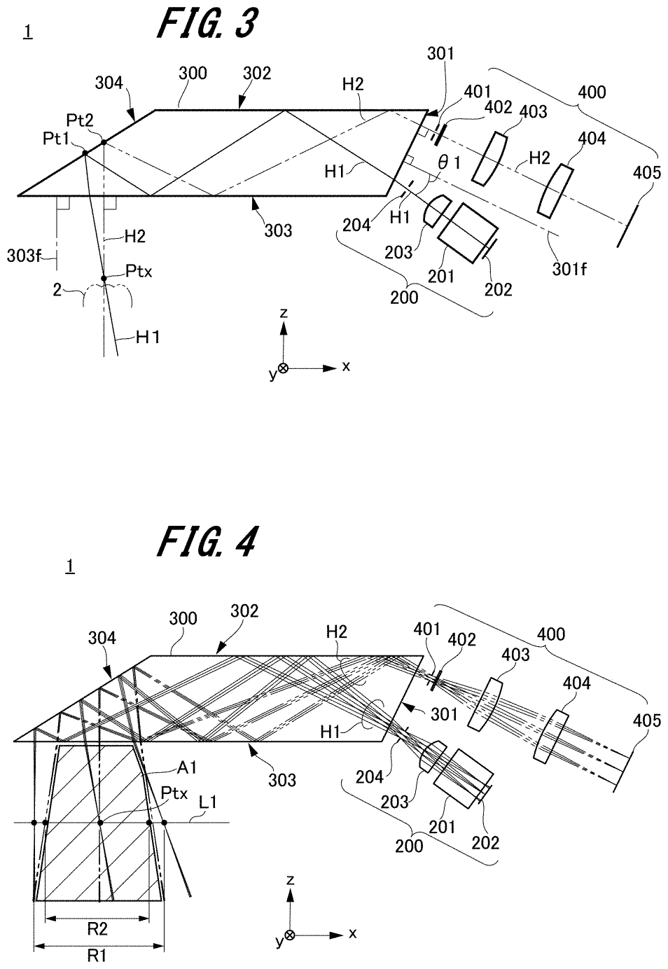

FIG. 3 is a view (part 1) illustrating schematic optical paths of light used in the intraoral measurement device 1 according to the embodiment. In FIG. 3, the intraoral measurement device 1 is viewed in y-direction of FIG. 1. FIG. 3 does not show the illuminator 100 that overlaps with the projector 200 in y-direction. The light H1 and the light H2 used in the intraoral measurement device 1 represent rays along the optical axes of the projector 200 and the imager 400, respectively.

As illustrated in FIG. 3, the projector 200 is placed such that an incident angle of the projection light H1 is oblique to the prism 300 to be described next. However, the projector 200 preferably has an optical axis parallel to, for example, xz-plane. In the prism 300, an inclination angle θ1 between the optical axis of the projector 200 and a normal 301f of an incident surface (first surface 301 to be described later) which the projection light H1 enters is, for example, about 10 degrees. This angle enables the following optical paths of the projection light H1 and the imaging light H2. Hereinafter, the polarized beam splitter 201, the display element 202, the projector lens 203, and the projector aperture 204 included in the projector 200 will be described in this order.

[Polarized Beam Splitter 201]

Referring to FIGS. 1 to 3, the polarized beam splitter 201 is a cube formed by bonding two triangular prisms and has a bonded surface 201a (see FIG. 2) to which a dielectric multilayer film is applied. Among light applied to the dielectric multilayer film, P-polarized light is transmitted and S-polarized light is reflected. The polarized beam splitter 201 is placed such that S-polarized light of the illumination light H0 entered from the illuminator 100 is reflected toward the display element 202.

[Display Element 202]

The display element 202 is a two-dimensional display element having pixels arranged two-dimensionally and is, for example, a reflective liquid crystal element such as liquid crystal on silicon (LCOS). The drawings show the display surface of the display element 202. The display element 202 is placed such that the illumination light H0 entered from the polarized beam splitter 201 of the illuminator 100 is reflected toward the polarized beam splitter 201.

The display element 202 rotates a polarization direction of the illumination light H0 (S-polarized light) reflected on pixels that are turned on, allows the illumination light H0 to enter the bonded surface 201a of the polarized beam splitter 201 as P-polarized light, and transmits the illumination light H0 through the polarized beam splitter 201. On the other hand, the display element 202 does not rotate a polarization direction of the illumination light H0 (S-polarized light) reflected on pixels that are turned off, allows the illumination light H0 to enter the bonded surface 201a of the polarized beam splitter 201 as S-polarized light, and reflects the illumination light H0 on the polarized beam splitter 201.

Accordingly, the display element 202 controls on/off of pixels and generates projection patterns for the illumination light H0 incident again on the polarized beam splitter 201, thereby obtaining the projection light H1. With the display element 202, without a physical drive mechanism, it is possible to obtain the projection light H1 having various projection patterns, to downsize the intraoral measurement device 1, and to simplify the device configuration.

[Projector Lens 203]

The projector lens 203 condenses the projection light H1 transmitted through the polarized beam splitter 201. The projector lens 203 is rotationally symmetric about the optical axis of the projector 200.

[Projector Aperture 204]

The projector aperture 204 includes an aperture window 204a (see FIG. 2) through which the projection light H1 passes and controls the passage of the projection light H1 condensed by the projector lens 203. Note that the optical axis of the projector 200 passes through the center of the aperture window 204a of the projector aperture 204. In addition, the shape of the aperture window 204a is rotationally symmetric about the optical axis of the projector 200. In FIGS. 1 and 3, the projection light H1 along the optical axis of the projector 200 passing through the center of the aperture window 204a of the projector aperture 204 is illustrated as a ray. In FIG. 2, the projection light H1 passing through the aperture window 204a of the projector aperture 204 is illustrated as a beam.

The projector aperture 204 is placed without involving other optical elements between the prism 300 and the projector aperture 204. An interval between the projector aperture 204 and the prism 300 is comparable with an interval between an imager aperture 401 (to be described) and the prism 300 and is, for example, about 3 mm. The aperture window 204a of the projector aperture 204 has a diameter of about 1.5 mm which is larger than a diameter of an aperture window of the imager aperture 401 (to be described). The arrangement of the projector aperture 204 will be described later in detail.

<Prism 300>

As illustrated in FIGS. 1 and 3, the prism 300 has an elongated shape. A leading end of the elongated shape is to be inserted into the oral cavity. In the prism 300, the projector 200 and the imager 400 are arranged on the side close to a base end opposite to the leading end of the elongated shape. The prism 300 internally reflects the projection light H1 supplied from the projector 200 on the base end for several times, guides the light to the leading end, and irradiates the object of interest 2 with the light. The prism 300 internally reflects the imaging light H2, that is, the projection light H1 reflected on the object of interest 2, for several times and guides the imaging light H2 toward the imager 400. In the prism 300, optical surfaces are all flat. The optical surfaces are a light transmissive surface and a light reflective surface.

The prism 300 herein is a rectangular column having, for example, two bottom faces with the same shape. Side walls of the rectangular column are perpendicular to xz-plane and parallel to y-direction, but the bottom surfaces may not be parallel to each other. In the prism 300, the side walls perpendicular to xz-plane are optical surfaces. The optical surfaces are, for example, the first surface 301, a second surface 302, a third surface 303, and a fourth surface 304. The projection light H1 reaches in this order. Hereinafter, configurations of the optical surfaces of the prism 300 will be described in order in which the projection light H1 reaches. Note that the imaging light H2 reaches these optical surfaces in reverse order.

[First Surface 301 (Light Transmissive Surface)]

The first surface 301 is disposed on the base end of the prism 300. The illuminator 100, the projector 200, and the imager 400 are arranged to face the first surface 301. The first surface 301 serves as a light transmissive surface, an incident surface of the projection light H1 emitted from the projector 200 to the prism 300, and an emitting surface of the imaging light H2 from the prism 300 to the imager 400. In other words, in the prism 300, the first surface 301 plays both roles as the incident surface of the projection light H1 and the emitting surface of the imaging light H2.

The first surface 301 is arranged in a state where the normal 301f of the first surface 301 is inclined relative to the optical axis of the projector 200. Accordingly, the projection light H1 enters the prism 300 obliquely. As described before, in the prism 300, the inclination angle θ1 between the normal 301f of the first surface 301 and the optical axis of the projector 200 is, for example, about 10 degrees which enables the following optical paths of the projection light H1 and the imaging light H2.

Furthermore, the first surface 301 is placed such that the normal 301f is parallel to the optical axis of the imager 400. Accordingly, the imaging light H2 emitted from the prism 300 and incident on the imager 400 has an emission angle perpendicular to the prism 300. In addition, the imaging light H2 emitted from the prism 300 has an inclination angle of, for example, about 10 degrees relative to the projection light H1 incident on the prism 300.

[Second Surface 302]

The second surface 302 is an elongated surface extending in x-direction from the base end toward the leading end of the prism 300 and corresponds to xy-plane having an acute internal angle formed with the first surface 301. Inside the prism 300, the second surface 302 reflects the projection light H1 transmitted through the first surface 301 and incident on the prism 300. The second surface 302 totally reflects the projection light H1 and allows the projection light H1 to enter the third surface 303. Furthermore, the second surface 302 totally reflects the imaging light H2 reflected on the object of interest 2 and incident again on the prism 300 and allows the imaging light H2 to enter the first surface 301 from the inside of the prism 300.

[Third Surface 303 (Imaging Surface)]

The third surface 303 may be a surface opposite to the second surface 302 and parallel to the second surface 302. In other words, the third surface 303 is an elongated surface extending in x-direction from the base end toward the leading end of the prism 300 and corresponds to xy-plane having an obtuse internal angle formed with the first surface 301. The third surface 303 is also an imaging surface having a leading end facing the object of interest 2.

The third surface 303 totally reflects the projection light H1 entered from the second surface 302 toward the fourth surface 304. The projection light H1 reflected on the fourth surface 304 enters the third surface 303 again. An angle of the projection light H1 re-entering from the fourth surface 304 to the third surface 303 is smaller than the total reflection angle. Accordingly, the third surface 303 emits the re-entered projection light H1 to the outside of the prism 300. Therefore, the third surface 303 also serves as an emitting surface of the projection light H1. The projection light H1 emitted from the third surface 303 is applied to the object of interest 2 that faces the third surface 303.

In addition, the third surface 303 transmits the imaging light H2, that is, the projection light H1 diffusely reflected on the object of interest 2. Therefore, the third surface 303 also serves as an incident surface of the imaging light H2. Herein, the optical axis of the imager 400 is parallel to a normal 303f of the third surface 303, and the imaging light H2 is perpendicularly incident on the prism 300.

As described above, the third surface 303 serves as a light transmissive surface and also as a light reflective surface. Furthermore, the third surface 303 is an emitting surface of the projection light H1 from the prism 300 to the object of interest 2 and is also an incident surface of the imaging light H2 from the object of interest 2 to the prism 300. In other words, in the prism 300, the third surface 303 playing both roles as the emitting surface of the projection light H1 and the incident surface of the imaging light H2 is used as the imaging surface that faces the object of interest 2.

In this embodiment, each of the projection light H1 and the imaging light H2 is totally reflected between the second surface 302 and the third surface 303 once, but the number of total reflections may be increased by further extending the prism 300 in x-direction.

[Fourth Surface 304]

The fourth surface 304 is disposed between the second surface 302 and the third surface 303 on the side close to the leading end of the prism 300. The fourth surface 304 has an obtuse angle relative to the second surface 302 and an acute angle relative to the third surface 303. The fourth surface 304 reflects the totally reflected projection light H1 between the second surface 302 and the third surface 303 toward the third surface 303 serving as the imaging surface. In addition, the fourth surface 304 reflects light transmitted through the third surface 303 and incident again on the prism 300 (that is, the imaging light H2) toward the third surface 303.

The fourth surface 304 is larger than the first surface 301 in x-direction. The prism 300 totally reflects the imaging light H2 reflected on the fourth surface 304 between the third surface 303 and the second surface 302 and emits the imaging light H2 from the first surface 301 toward the imager 400. Furthermore, the prism 300 reflects the projection light H1 totally reflected between the third surface 303 and the second surface 302 on the fourth surface 304 and emits the projection light H1 from the third surface 303 or the imaging surface. Such a configuration makes it is possible to thin the leading end of the prism 300 where the fourth surface 304 is placed. Accordingly, the leading end of the prism 300 is easily inserted into the oral cavity, thereby decreasing patient burden of inserting the intraoral measurement device 1 into the oral cavity.

In this embodiment, the third surface 303 plays a role as the imaging surface which is the emitting surface of the projection light H1 and the incident surface of the imaging light H2, but the second surface 302 may be the imaging surface. In this case, the fourth surface 304 is arranged at an acute angle relative to the second surface 302 and an obtuse angle relative to the third surface 303.

<Imager 400>

The imager 400 is an optical system for imaging the imaging light H2 emitted from the prism 300. The imager 400 includes the imager aperture 401, a polarizing plate 402, two imager lenses 403 and 404, and an imaging element 405 along the route of the optical path of the imaging light H2 emitted from the prism 300.

In addition, the imager 400 is placed such that the optical axis accords with the center line of a beam of the imaging light H2 emitted perpendicularly from the first surface 301 of the prism 300 and that the optical axis is perpendicular to the first surface 301 of the prism 300. In other words, in the prism 300, the normal 301f of the first surface 301 from which the imaging light H2 is emitted is parallel to the optical axis of the imager 400. Furthermore, the optical axis of the imager 400 is parallel to xz-plane. On the other hand, as described above, the optical axis of the imager 400 is inclined relative to the optical axis of the projector 200. Accordingly, the projector 200 is arranged without physically interfering with the imager 400. Hereinafter, each element included in the imager 400 will be described in the following order: the imager aperture 401, the polarizing plate 402, the two imager lenses 403 and 404, and the imaging element 405.

[Imager Aperture 401]

The imager aperture 401 includes an aperture window through which the imaging light H2 passes and controls the imaging light H2 emitted from the first surface 301 of the prism 300. Note that the optical axis of the imager 400 passes through the center of the aperture window of the imager aperture 401 and that the shape of the aperture window is rotationally symmetric about the optical axis of the imager 400. FIGS. 1 and 3 illustrate the imaging light H2 passing through the center of the imager aperture 401.

The imager aperture 401 is placed without involving other optical elements between the prism 300 and the imager aperture 401. The interval between the imager aperture 401 and the prism 300 is comparable with the aforementioned interval between the projector aperture 204 and the prism 300 and is, for example, about 3 mm. The aperture window of the imager aperture 401 has a diameter of about 1.0 mm which is smaller than the diameter of the aperture window of the projector aperture 204. The arrangement of the imager aperture 401 will now be described in detail.

[Polarizing Plate 402]

The polarizing plate 402 is disposed between the imager aperture 401 and the imager lens 403 while maintaining a position that does not allow transmission of specularly reflected light of the projection light H1 on the object of interest 2 among the imaging light H2 diffusely reflected on the object of interest 2. In other words, the projection light H1 entering the prism 300 from the projector 200 is linearly polarized light as described above. Accordingly, the polarizing plate 402 in a predetermined state blocks passage of the light specularly reflected on the object of interest 2 among the imaging light H2 or the projection light H1 reflected on the object of interest 2, thereby allowing transmission of scattered light on the object of interest 2.

This makes it possible to cut specularly reflected light having particularly high light intensity and to allow the imaging light H2 including scattered light having stable light intensity to enter the imaging element 405 (to be described), thereby facilitating analysis of an image obtained by the imaging element 405.

Here, the imaging light H2 reflected on the object of interest 2 includes both the scattered light and the specularly reflected light. The specularly reflected light is directed to the imaging element 405 when a local normal on the reflective surface accords with the bisector of the projection light H1 and the imaging light H2 passing through the point, and such light is very limited in the visual field. Furthermore, an amount of light depends on the surface state of the object of interest 2. Particularly, when the object of interest 2 is wet, an amount of specularly reflected light is much larger than that of scattered light. Therefore, in order to capture an image with high accuracy, it is desirable to cut off the specularly reflected light and allow the scattered light to enter the imaging element 405.

[Imager Lenses 403 and 404]

The imager lenses 403 and 404 are sequentially arranged along the optical path of the imaging light H2 passing through the polarizing plate 402 and allow the imaging light H2 passing through the polarizing plate 402 to enter the imaging element 405. These imager lenses 403 and 404 are rotationally symmetric about the optical axis of the imager 400.

[Imaging Element 405]

The imaging element 405 is not limited as long as it includes light receiving elements arranged two-dimensionally. The drawing illustrates the light receiving surface of the imaging element 405.

<<Optical Paths of Projection Light H1 and Imaging Light H2>>

Next, the optical paths of light used in the intraoral measurement device 1 according to the embodiment will be described with reference to FIGS. 1, 3, and other drawings. Furthermore, the configuration of the intraoral measurement device 1 will be described in more detail.

<Optical Path of Projection Light H1>

As illustrated in FIG. 1 and FIG. 3, the projection light H1 emitted from the projector 200 to the prism 300 is incident on the prism 300 from an oblique direction relative to the first surface 301 of the prism 300 along xz-plane. The projection light H1 incident on the prism 300 is totally reflected on the second surface 302 of the prism 300, incident on and totally reflected on the third surface 303 parallel to the second surface 302, and incident on the fourth surface 304. The fourth surface 304 is arranged at an acute angle relative to the third surface 303. The projection light H1 incident on the fourth surface 304 enters the third surface 303 again at an angle lower than a critical angle at which the projection light H1 is totally reflected, and then, the projection light H1 is transmitted through the third surface 303 and applied to the object of interest 2.

Accordingly, the projection light H1 applied to the object of interest 2 is reflected on the fourth surface 304 arranged at an acute angle relative to the third surface 303 before being emitted from the third surface 303 as the imaging surface of the prism 300 facing the object of interest 2. Furthermore, the projection light H1 is totally reflected on the third surface 303 before the reflection.

The aforementioned path of the projection light H1 is along xz-plane including the inside of the prism 300.

<Optical Path of Imaging Light H2>

The projection light H1 applied to the object of interest 2 is diffusely reflected on the object of interest 2 and enters the third surface 303 as the imaging light H2. The imaging light H2 incident on the third surface 303 is transmitted through the third surface 303, enters the prism 300, and also enters the fourth surface 304. Among the imaging light H2 reflected on the fourth surface 304 and incident again on the third surface 303, the imaging light H2 totally reflected on the third surface 303 is incident on the second surface 302, totally reflected on the second surface 302, and incident on the first surface 301. The imaging light H2 totally reflected on the second surface 302 and incident on the first surface 301 is transmitted through the first surface 301, emitted from the prism 300, and incident on the imager 400.

As described above, the imaging light H2 diffusely reflected on the object of interest 2 and transmitted through the third surface 303 as the imaging surface of the prism 300 is reflected on the fourth surface 304 arranged at an acute angle relative to the third surface 303, and then, incident on the third surface 303 again and totally reflected. After multiple reflections, the imaging light H2 is emitted from the prism 300, and the imaging light H2 transmitted through the imager aperture 401 enters the imaging element 405.

The path of the imaging light H2 as described above is an optical path along xz-plane including the inside of the prism 300. The optical axis of the imager 400 and the optical axis of the projector 200 are along the same xz-plane which is a symmetry plane common to the projector 200, the prism 300, and the imager 400 and also a symmetry plane common to the projection light H1 and the imaging light H2. The configuration with such a symmetry plane makes it possible, for example, to clarify what kind of projection patterns is to be generated by the display element 202 in triangulation when performing profilometry of the object of interest 2. In this case, projection patterns generated by the display element 202 are, for example, fringe patterns for profilometry of the object of interest 2. The configuration of such projection patterns will be described in detail below.

In the above configuration, preferably, an incident point Pt1 of the projection light H1 relative to the fourth surface 304 of the prism 300 is closer to the leading end of the prism 300 than an incident point Pt2 of the imaging light H2. In other words, a distance between the incident point Pt1 of the projection light H1 relative to the fourth surface 304 and the third surface 303 is preferably smaller than a distance between the incident point Pt2 of the imaging light H2 relative to the fourth surface 304 and the third surface 303. Accordingly, the incident point Pt2 of the imaging light H2 is shifted to a position where the thickness of the prism 300 is relatively large and the shape accuracy is easily maintained, compared to the incident point Pt1 of the projection light H1 relative to the fourth surface 304 of the prism 300, thereby keeping the high accuracy of the imaging light H2.

In addition, an intersection point Ptx between the projection light H1 emitted from the prism 300 and the imaging light H2 incident on the prism 300 is preferably outside the prism 300. Accordingly, for imaging of the object of interest 2, it is possible to effectively utilize a range in which the projection light H1 and the imaging light H2 are close to the center lines along the optical axes of the projector 200 and the imager 400 and close to the centers of the lenses.

Intervals and angles between the first surface 301, the second surface 302, the third surface 303, and the fourth surface 304 of the prism 300, and the positional relation between the projector 200 and the imager 400 relative to the prism 300 are adjusted so as to form the aforementioned optical paths.

<Irradiation Ranges of Projection Light H1 and Imaging Light H2>

FIG. 4 is a view (part 2) illustrating schematic optical paths of light used in the intraoral measurement device 1 according to the embodiment. In this drawing, the intraoral measurement device 1 is viewed in y-direction of FIG. 1. In FIG. 4, the projection light H1 and the imaging light H2 used in the intraoral measurement device 1 are illustrated as beams. The projection light H1 and the imaging light H2 are illustrated as rays passing through three points, that is, the center and both ends of the range used for imaging. The projection light H1 and the imaging light H2 pass the centers of the projector aperture 204 and the imager aperture 401 and the upper and lower ends of the drawing. Furthermore, FIG. 4 illustrates the optical paths of the projection light H1 and the imaging light H2 in xz-plane along the optical axes of the projector 200 and the imager 400, that is, a symmetry plane (xz-plane) common to the projector 200, the prism 300, and the imager 400.

As illustrated in FIG. 4, in the symmetry plane (xz-plane), a range R1 of the projection light H1 is wider than a range R2 of the imaging light H2 on a straight line L1 parallel to the third surface 303 and passing through the intersection point Ptx between the center line of the projection light H1 along the optical axis of the projector 200 and the center line of the imaging light H2 along the optical axis of the imager 400. In the range R1 of the projection light H1, projection patterns (to be described) are generated for the projection light H1. In addition, the range R2 of the imaging light H2 is used for imaging by the imaging element 405 with the imaging light H2.

In a space on the side close to the object of interest 2, a region A1 where the range R1 of the projection light H1 and the range R2 of the imaging light H2 overlap with each other is a region used for imaging. Even when the projection light H1 with the following projection patterns is projected onto the object of interest 2, the imaging element 405 cannot capture an image outside the range R2 of the imaging light H2. Furthermore, even within the range R2 of the imaging light H2, an image cannot be captured unless the projection light H1 is emitted.

Therefore, the range R1 of the projection light H1 is increased because the required accuracy of the optical system is low and the projection light H1 is less affected adversely in performance even when an irradiation angle is extended. Accordingly, even when the object of interest 2 is deviated in z-direction from the intersection point Ptx between the center line of the projection light H1 and the center line of the imaging light H2, the range R2 of the imaging light H2 is included in the range R1 of the projection light H1, thereby making best use of the field of view by the imaging light H2.

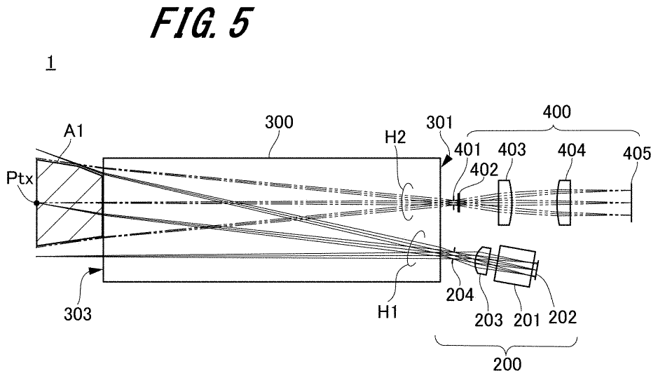

FIG. 5 is a developed view illustrating the configuration of the intraoral measurement device 1 according to the embodiment. In the developed view herein, the reflective surface is omitted, and light is redrawn as travelling in a straight line. The developed view of FIG. 5 corresponds to FIG. 4. In the developed view, the projection light H1 and the imaging light H2 are redrawn as travelling inside the prism 300 in straight lines.

In this embodiment, the number of reflections of the projection light H1 and the imaging light H2 inside the prism 300 is an odd number (see FIG. 4). After the odd-numbered reflections in the developed view, a mirror image is formed. Therefore, with regard to a space on the side close to the base end of the prism 300 where the projector 200 and the imager 400 are placed, FIG. 5 coincides with FIG. 4 and overlaps with FIG. 4 by rotation and displacement of the space. On the other hand, in FIGS. 4 and 5, a mirror image is formed in a space on the side close to the leading end of the prism 300 where the object of interest 2 is provided, so that FIGS. 4 and 5 overlap with each other when either one is inverted. In FIG. 5, note that absolute values of distances and angles are matched with those in FIG. 4, but lengths of rays on the side close to the object of interest 2 are changed. In FIG. 4, rays are extended to positions farthest from the prism 300 in the assumed imaging region Al, while in FIG. 5, rays are extended to the center of the assumed imaging region A1.

In the developed view of FIG. 5, it can be seen that the two transmissive surfaces of the prism 300, that is, the first surface 301 and the third surface 303, are parallel. In addition, it can be seen that the imager 400 is not inclined relative to the transmissive surfaces (the first surface 301 and the third surface 303) of the prism 300, and the projector 200 is inclined relative to the transmissive surfaces of the prism 300. The projector 200 is axisymmetric except for the prism 300, and an axis of rotational symmetry of the projector 200 is inclined at an angle of 10 degrees relative to normals of the transmissive surfaces (the first surface 301 and the third surface 303) of the prism 300. The developed view shows that the imager 400 is axisymmetric including the transmissive surfaces (the first surface 301 and the third surface 303) of the prism 300.

<Arrangement of Projector Aperture 204 and Imager Aperture 401>

As illustrated in FIG. 5, the projection light H1 and the imaging light H2 overlap each other in the space on the side close to the object of interest 2 and have different angles relative to the prism 300. Therefore, an interval between the projection light H1 and the imaging light H2 widens when the projection light H1 and the imaging light H2 move away from the object of interest 2 and approach the projector 200 and the imager 400.

In such a state, other optical elements (mainly a lens) are not involved between the prism 300 and the projector aperture 204 and between the prism 300 and the imager aperture 401. Accordingly, it is possible to reduce distances between the prism 300 and the projector aperture 204 and between the prism 300 and the imager aperture 401. This makes it possible to reduce ranges where the projection light H1 passes and the imaging light H2 passes on the first surface 301 of the prism 300. Therefore, even with an increase of an interval between the ranges where the projection light H1 and the imaging light H2 pass, it is possible to keep the first surface 301 of the prism 300 small, and it is possible to downsize the prism 300, that is, to downsize the intraoral measurement device 1.

With such a configuration, the closer the object of interest 2 gets to the prism 300, the larger the object of interest 2 appears. Therefore, calculation correction is required in profilometry of the object of interest 2 based on an image captured by the imaging element 405. At this time, a distance between the projector aperture 204 and the first surface 301 of the prism 300 on the side where the projector 200 and the imager 400 are disposed and a distance between the imager aperture 401 and the first surface 301 are made equal. Accordingly, the calculation correction is not necessary. This is because equalizing the distance between the first surface 301 and the projector aperture 204 and the distance between the first surface 301 and the imager aperture 401 provides a balance. That is, the closer the object of interest 2 gets to the third surface 303 of the prism 300, the smaller the projection patterns generated for the projection light H1 applied to the object of interest 2, and the wider the imaging light H2 spreads. It is necessary to reflect inclinations of rays when depth data obtained by the imaging element 405 is converted into a three-dimensional point group. Furthermore, the intraoral measurement device 1 in practice has an individual manufacturing error. Therefore, individual calibration is a key requirement, but the aforementioned configuration is advantageous in that side effects associated with the calibration are less likely to occur.

In addition, the projector aperture 204 and the imager aperture 401 with larger diameters are more favorable in amount of the projection light H1 and the imaging light H2. However, there is a trade-off problem. That is, the larger the diameters of the projector aperture 204 and the imager aperture 401, the greater the image changes when a distance to the object of interest 2 is changed. Therefore, as described below, it is preferable to keep a focal depth by setting the diameter of the projector aperture 204 of the imager 400 to be smaller (for example, 1.0 mm) than the diameter of the imager aperture 401 of the projector 200 (for example, 1.5 mm) that projects fringe patterns with low spatial frequencies.

Considering the projector 200 and the imager 400 together, a difference in inclination between these optical axes relative to the normal 301f of the first surface 301 is 10 degrees in the air and is about 6.5 degrees in the prism 300. With such a difference, the centers of the two optical systems move away from each other with distance from the center of a measurable range, thereby determining how much the width of the surface is to be used. For example, when telecentric optical systems are used, the optical systems use substantially equal ranges. Accordingly, a deviation of the centers increases a range obtained by combining the ranges of the optical systems. On the other hand, in the optical systems according to the embodiment, ranges used by the projector 200 and the imager 400 become narrower as the ranges get closer to the apertures 204 and 401, and such an effect is greater than the effect obtained by the separated centers. The drawing shows that the farther the two optical systems get from the center of the measurable range, the narrower the total range of the two optical systems.

In this way, placing the apertures 204 and 401 immediately after the prism 300 is advantageous in size of the device but disadvantageous in that the shape of the object of interest 2 appears to change depending on the distance from the third surface 303 or the imaging surface. In telecentric optical systems, the shape of the object of interest 3 appears the same regardless of the distance from the imaging surface. However, in the optical systems according to this embodiment, the closer the optical systems get to the third surface 303 or the imaging surface, the larger the size of the object of interest 2 appears, and the farther the optical systems get from the third surface 303, the smaller the size of the object of interest 2 appears. Furthermore, a period of fringes of the projection patterns generated for the projection light H1 also changes depending on the distance between the third surface 303 or the imaging surface and the object of interest 2. The shorter the distance, the shorter the period of the fringes. Therefore, in this embodiment, the distances from the prism 300 to the apertures 204 and 401 are made substantially equal, thereby offsetting the change in size of the object of interest 2 viewed by the imager 400 with the change in period of the fringes of the projection patterns generated in the projector 200. Accordingly, as described below, it is not necessary to consider the apparent periodic change due to the distance when a phase of the fringes of the projection patterns is converted into a height of the object of interest 2. When a two-dimensional distribution of height is converted into a three-dimensional point group, it is necessary to calculate on the assumption that a ray of the imaging light H2 flies off obliquely, but it does not matter because the conversion is performed with an inclination determined for each pixel of the imaging element 405. As described above, the distances from the prism 300 to the apertures 204 and 401 along the optical axes are both 3 mm, and the optical axis of the projector 200 is inclined at an angle of 10 degrees relative to the normal 301f of the first surface 301. Accordingly, the distance between the first surface 301 of the prism 300 and the projector aperture 204 in the direction of the normal 301f is 2.95 mm, but such a minor difference is sufficiently smaller than the distances from the apertures 204 and 401 to the object of interest 2, which causes no problem.

<<Projection Pattern>>

Hereinafter described are projection patterns projected onto the object of interest 2 in the intraoral measurement device 1. The projection patterns herein are generated for the projection light H1 by turning on and off a plurality of pixels included in the display element 202 of the projector 200 and are used for profilometry of the object of interest 2.

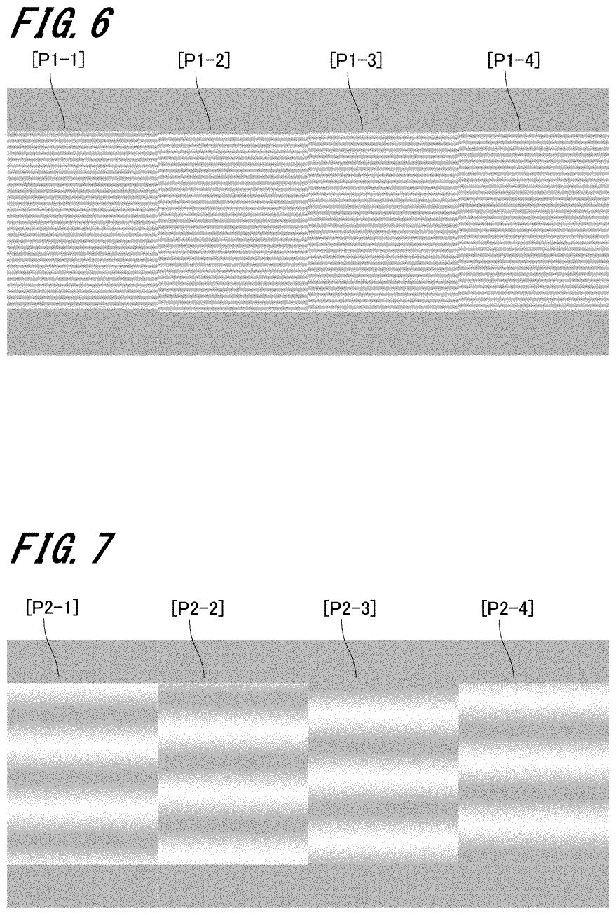

FIG. 6 is a view (part 1) illustrating projection patterns projected onto an object of interest in the intraoral measurement device 1 according to the embodiment. As illustrated in FIG. 6, projection patterns [P1-1], [P1-2], . . . projected onto the object of interest are fringes formed by sine waves. The intraoral measurement device 1 sequentially generates the projection patterns [P1-1], [P1-2], . . . by a phase shifting technique and projects the generated projection patterns onto the object of interest.

The number of phase changes is desirably four or more. The illustrated example shows the four projection patterns [P1-1], [P1-2], . . . in which phases of the sine waves are changed by 90 degrees. In this manner, four or more times of phase changes enables profilometry of an object of interest utilizing the phase shifting technique.

FIG. 7 is a view (part 2) illustrating projection patterns projected onto an object of interest in the intraoral measurement device 1 according to the embodiment. The projection patterns have a period larger than that of the projection patterns illustrated in FIG. 6. It is preferable that the intraoral measurement device 1 sequentially shifts phases of projection patterns and generates the projection patterns [P1-1], [P1-2], . . . and projection patterns [P2-1], [P2-2], . . . having different periods, as shown in FIGS. 6 and 7, thereby projecting the generated projection patterns onto an object of interest.

In the phase shifting technique, a degree of change in phase of fringes applied to an object of interest is converted into a height. At that time, if projection patterns are shifted by one fringe, the phase shift is regarded as zero, and the height cannot be calculated correctly. To calculate correctly, fringes may be made coarse so that fringes within an assumed height shift by less than one fringe. However, fringes with a large period increase errors in height measurement due to errors in brightness. Therefore, generation of a plurality of types of projection patterns with different periods as illustrated in FIGS. 6 and 7 and combination of fine fringes with coarse fringes make it possible to achieve both high accuracy and a wide measurable range.

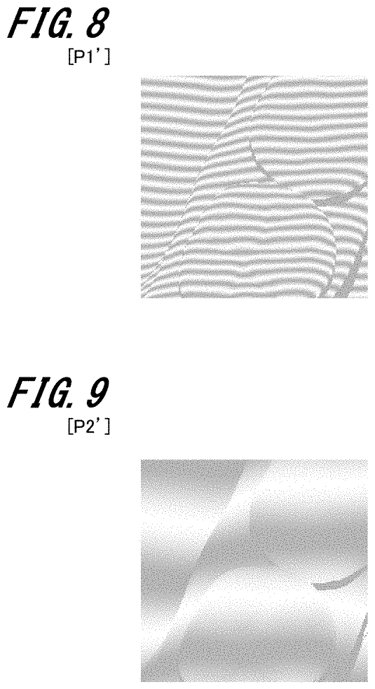

FIGS. 8 and 9 are views (part 1) and (part 2) illustrating imaging patterns captured with the intraoral measurement device 1 according to the embodiment. Imaging patterns [P1′] and [P2′] illustrated in the drawings are images obtained when sinusoidal patterns are projected onto teeth in the oral cavity and created by simulation using a 3D model. As can be seen in the drawings, the images obtained by reflecting the sinusoidal patterns on an object of interest reflects the effect that the object of interest appears larger as it gets closer to the prism 300 but does not reflect blurring of the optical systems.

The phase of the imaging pattern [P1′] having fringes with a small period illustrated in FIG. 8 shifts by one period when there is a height difference of 5 mm. In other words, portions with a height difference of 5 mm are indistinguishable from portions with the same height. A height difference much smaller than 5 mm can be measured correctly, but a height difference close to 5 mm cannot be measured correctly.

The imaging pattern [P2′] having fringes with a large period illustrated in FIG. 9 has a period ten times that of the fringes with the small period. Although the imaging pattern [P2′] increases a measurable range, it is not suitable to measure a minor difference. Accordingly, calculation by a combination of these two patterns enables both a sufficient measurement range and accuracy.

Viewed from above the imaging element 405 (see FIG. 4), when fringes of projection patterns reaching the imaging element 405 have too fine a period relative to a pixel pitch of the imaging element 405, it is difficult to measure phases. In a case where fringes are measured spatially, the fringes are required to have a period at least twice the pixel pitch, but phases cannot be measured when the period is exactly twice the pixel pitch. In the phase shifting technique, since phases of fringes are shifted temporally, phases can be calculated even when the period is twice the pixel pitch. However, a contrast attributed to an aperture area is greatly reduced.

Therefore, in sine waves included in the aforementioned projection patterns, spatial frequencies on the imaging surface of the imaging element 405 are preferably smaller than ¼ of the reciprocal of the pixel pitch of the imaging element 405. In other words, it is preferable that the fringes of the projection patterns reaching the imaging element 405 have a period larger than four times the pixel pitch of the imaging element 405. Such a configuration suppresses the reduction of the contrast, thereby enabling phase measurement. For example, the lower limit of the period of fringes of the projection patterns is set to about 30 times the pixel pitch of the imaging element 405. In this case, phases are measured without any problem, and the phases of fringes of the projection patterns are calculated in the imaging element 405 with high accuracy.

In addition, the display element 202 preferably generates projection patterns as described above such that brightness is changed in the symmetry plane common to the projector 200, the prism 300, and the imager 400 and that brightness becomes constant in a direction perpendicular to the common symmetry plane. The common symmetry plane herein is xz-plane illustrated in FIGS. 3 and 5 and is a plane along the optical axes of the projector 200 and the imager 400.

Using the sine waves as the projection patterns generated by the display element 202, even when the optical system of the projector 200 has a low performance, it is possible to apply the projection patterns stably.

FIGS. 6 and 7 show black portions above and below the projection patterns [P1-1], [P1-2], . . . and the projection patterns [P2-1], [P2-2], . . . , but these portions are not used for profilometry of the object of interest 2.

In FIGS. 6 and 7, each of the projection patterns [P1-1], [P1-2], . . . is applied in a rectangular shape with a width increased in a direction in which the projection light H1 obliquely enters the prism 300. How much the width of the rectangle is increased depends on how much the projector 200 is inclined relative to the first surface 301 of the prism 300 and depends on the assumed height of a measurement range (range of distance from the third surface 303 or the imaging surface of the prism 300). For example, when the rectangle used for irradiation of each of the projection patterns [P1-1], [P1-2], . . . is approximately 6:5, and when the rectangle of a display area of the display element 202 is 16:9, the longitudinal side of the display element 202 is surplus.

<<Effects of Embodiment>>

In the configuration of the intraoral measurement device 1 according to the embodiment in which the projection light H1 is guided to the object of interest 2 using the prism 300, the optical axis of the imager 400 is parallel to the normal 301f of the incident surface (first surface 301) and the normal 303f of the emitting surface (third surface 303) of the imaging light H2 in the prism 300. Accordingly, even though the intraoral measurement device 1 includes the prism 300, it is possible to simplify a complicated configuration of the imager 400 required for aberration correction. Furthermore, even with the simple configuration, the intraoral measurement device 1 enables high-accuracy profilometry.

### EXAMPLE

Examples of the intraoral measurement device 1 according to the embodiment are specifically shown in the following Table 1. Table 1 numerically shows Examples of the present invention.

TABLE 1

| | | POSITION | | | DIRECTION VECTOR | | | | REFRACTIVE |
|---|---|---|---|---|---|---|---|---|---|
| | | X | Y | Z | X | Y | Z | CURVATURE | INDEX |
| 101 LIGHT SOURCE | | −26.93 | −95.40 | 10.00 | 0.58779 | 0.80902 | 0.00000 | 0.0000 | |
| 102 ILLUMINATORLENS | | −12.82 | −75.99 | 10.00 | 0.58779 | 0.80902 | 0.00000 | 0.0000 | 1.5190 |
| | | −9.88 | −71.94 | 10.00 | 0.58779 | 0.80902 | 0.00000 | −0.1000 | |
| 103 MIRROR | | −6.94 | −67.90 | 10.00 | 0.41563 | 0.57206 | 0.70711 | 0.0000 | |
| 201 POLARIZED BEAM | | −6.94 | −67.90 | 4.00 | 0.00000 | 0.00000 | −1.00000 | 0.0000 | 1.5190 |
| SPLITTER | | −6.94 | −67.90 | 0.00 | 0.41563 | 0.57206 | −0.70711 | 0.0000 | |
| | | −9.30 | −71.13 | 0.00 | −0.58779 | −0.80902 | 0.00000 | 0.0000 | |
| 202 DISPLAY ELEMENT | | −9.88 | −71.94 | 0.00 | −0.58779 | −0.80902 | 0.00000 | 0.0000 | |
| (LCOS) | | | | | | | | | |
| 201 POLARIZED BEAM | | −9.30 | −71.13 | 0.00 | 0.58779 | 0.80902 | 0.00000 | 0.0000 | 1.5190 |
| SPLITTER | | −4.59 | −64.66 | 0.00 | 0.58779 | 0.80902 | 0.00000 | 0.0000 | |
| 203 PROJECTOR LENS | | −3.42 | −63.04 | 0.00 | 0.58779 | 0.80902 | 0.00000 | 0.0000 | 1.5190 |
| | | −1.66 | −60.62 | 0.00 | 0.58779 | 0.80902 | 0.00000 | −0.2148 | |
| 204 PROJECTOR APERTURE | | 1.28 | −56.57 | 0.00 | 0.58779 | 0.80902 | 0.00000 | 0.0000 | |
| 300 PRISM | 301 | 3.05 | −54.15 | 0.00 | 0.43837 | 0.89879 | 0.00000 | 0.0000 | 1.5338 |
| | 302 | 16.00 | −30.00 | 0.00 | 1.00000 | 0.00000 | 0.00000 | 0.0000 | |
| | 303 | 0.00 | −30.00 | 0.00 | −1.00000 | 0.00000 | 0.00000 | 0.0000 | |
| | 304 | 10.00 | 0.00 | 0.00 | 0.84805 | 0.52992 | 0.00000 | 0.0000 | |
| | 303 | 0.00 | 0.00 | 0.00 | −1.00000 | 0.00000 | 0.00000 | 0.0000 | |
| 2 OBJECT OF INTEREST | | −15.00 | 0.00 | 0.00 | 1.00000 | 0.00000 | 0.00000 | 0.0000 | |
| (CENTER) | | | | | | | | | |
| 300 PRISM | 303 | 0.00 | 0.00 | 0.00 | 1.00000 | 0.00000 | 0.00000 | 0.0000 | 1.5338 |
| | 304 | 10.00 | 0.00 | 0.00 | 0.84805 | 0.52992 | 0.000000 | 0.0000 | |
| | 303 | 0.00 | −30.00 | 0.00 | −1.00000 | 0.00000 | 0.00000 | 0.0000 | |
| | 302 | 16.00 | −30.00 | 0.00 | 1.00000 | 0.00000 | 0.00000 | 0.0000 | |
| | 301 | 13.18 | −59.09 | 0.00 | −0.43837 | −0.89879 | 0.00000 | 0.0000 | |

| 401 IMAGER APERTURE | 11.87 | −61.78 | 0.00 | −0.43837 | −0.89879 | 0.00000 | 0.0000 | |
|---|---|---|---|---|---|---|---|---|
| 402 POLARIZING PLATE | 11.43 | −62.68 | 0.00 | −0.43837 | −0.89879 | 0.00000 | 0.0000 | 1.5190 |
| | 11.30 | −62.95 | 0.00 | −0.43837 | −0.89879 | 0.00000 | 0.0000 | |
| 403 IMAGER LENS 1 | 7.44 | −70.86 | 0.00 | −0.43837 | −0.89879 | 0.00000 | 0.0000 | 1.8565 |
| | 6.12 | −73.56 | 0.00 | −0.43837 | −0.89879 | 0.00000 | −0.0487 | |
| 404 IMAGER LENS 2 | 1.69 | −82.66 | 0.00 | −0.43837 | −0.89879 | 0.00000 | 0.0427 | 1.5190 |
| | 0.37 | −85.35 | 0.00 | −0.43837 | −0.89879 | 0.00000 | 0.0000 | |
| 405 IMAGING ELEMENT | −5.65 | −97.70 | 0.00 | −0.43837 | −0.89879 | 0.00000 | 0.0000 | |

Although embodiments of the present invention have been described and illustrated in detail, the disclosed embodiments are made for purposes of illustration and example only and not limitation. The scope of the present invention should be interpreted by terms of the appended claims.

### DESCRIPTION OF REFERENCE NUMERALS

1 . . . intraoral measurement device
2 . . . object of interest
200 . . . projector
201 . . . polarized beam splitter
202 . . . display element
204 . . . projector aperture
300 . . . prism
301 . . . first surface (light transmissive surface)
302 . . . third surface (imaging surface)
301f . . . normal of first surface
303f . . . normal of imaging surface
304 . . . fourth surface (reflective surface of prism inclined relative to imaging surface)
400 . . . imager
401 . . . imager aperture
402 . . . polarizing plate
405 . . . imaging element
H1 . . . projection light
H2 . . . imaging light
L1 . . . straight line parallel to imaging surface
Pt1 . . . point which projection light enters
Pt2 . . . point which imaging light enters
R1 . . . range where projection patterns are generated
R2 . . . range used for imaging
[P1-1], [P1-2], . . . [P2-1], [P2-2] . . . projection patterns

1. An intraoral measurement device comprising:
a projector that emits projection light;
an imager that receives imaging light, that is, the projection light reflected on an object of interest; and
a prism that guides the projection light emitted from the projector to the object of interest and guides the imaging light or the projection light reflected on the object of interest toward the imager, the prism being disposed on an optical path between the projector and the imager,
wherein the prism includes a light transmissive surface playing both roles as an incident surface of the projection light and an emitting surface of the imaging light and includes an imaging surface facing the object of interest and playing both roles as an emitting surface of the projection light and an incident surface of the imaging light, and
the imager has an optical axis parallel to a normal of the light transmissive surface and a normal of the imaging surface of the prism.

2. The intraoral measurement device according to claim 1,
wherein the projector has an optical axis inclined relative to the normal of the light transmissive surface of the prism and the normal of the imaging surface.

3. The intraoral measurement device according to claim 2,
wherein, in a developed view of the projector, the prism, and the imager, the projector is axisymmetric, and
an optical system including the imager and the prism is axisymmetric.

4. The intraoral measurement device according to claim 1,
wherein all optical surfaces of the prism including the light transmissive surface and the imaging surface are flat.

5. The intraoral measurement device according to claim 1,
wherein the imager includes an aperture and an imaging element arranged in order from the prism,
the imaging light entering the prism from the imaging surface is internally reflected on a reflective surface of the prism inclined relative to the imaging surface, incident on the imaging surface again, totally reflected at least on the imaging surface, and then, emitted from the light transmissive surface, and
the imaging light passing through the aperture enters the imaging element.

6. The intraoral measurement device according to claim 4,
wherein the projection light entering the prism from the light transmissive surface is totally reflected at least on the imaging surface, reflected on a reflective surface of the prism inclined relative to the imaging surface, incident on the imaging surface again, and emitted from the imaging surface.

7. The intraoral measurement device according to claim 5,
wherein a distance between the imaging surface and a point at which the projection light enters the reflective surface of the prism inclined relative to the imaging surface is smaller than a distance between the imaging surface and a point at which the imaging light enters the reflective surface of the prism inclined relative to the imaging surface.

8. The intraoral measurement device according to claim 1,
wherein the projector includes a display element that generates a projection pattern for the projection light.

9. The intraoral measurement device according to claim 8,
wherein the projection light and the imaging light have an optical path along a common symmetry plane, and
the display element generates the projection pattern that changes in brightness sinusoidally in the symmetry plane and remains constant in brightness in a direction perpendicular to the symmetry plane.

10. The intraoral measurement device according to claim 9,
wherein the display element generates four or more kinds of projection patterns of sine waves equal in period but different in phase.

11. The intraoral measurement device according to claim 10,
wherein the display element generates two or more kinds of projection patterns with different periods.

12. The intraoral measurement device according to claim 9,
wherein a center line of the projection light along an optical axis of the projector and a center line of the imaging light along the optical axis of the imager intersect outside the imaging surface of the prism.

13. The intraoral measurement device according to claim 12,
wherein, in the symmetry plane, a range used for generating the projection pattern for the projection light is wider than a range used for imaging by the imaging element with the imaging light on a straight line parallel to the imaging surface and passing through a point where a center line of the projection light and a center line of the imaging light intersect outside the imaging surface of the prism.

14. The intraoral measurement device according to claim 9,
wherein a spatial frequency of a sine wave included in the projection pattern is smaller than ¼ of the reciprocal of a pixel pitch of an imaging element on an imaging surface of the imaging element disposed in the imager.

15. The intraoral measurement device according to claim 8,
wherein the projector includes the display element and a polarized beam splitter and allows the projection light to enter the prism as linearly polarized light, and
the imager includes a polarizing plate and an imaging element arranged in order from the prism,
the polarizing plate being placed to shield specularly reflected light of the projection light on the object of interest among the imaging light.

16. The intraoral measurement device according to claim 1,
wherein the projector and the imager each include an aperture between the prism and the projector and the imager without involving another optical element.

17. The intraoral measurement device according to claim 16,
wherein the aperture of the projector has a diameter larger than a diameter of the aperture of the imager.
